(19) United States
(12) Patent Application Publication
(10) Pub. No.: US 2013/0176736 A1
(43) Pub. Date: Jul. 11, 2013

(54) Light Emitting Diode (LED) Lighting Assembly With Adjustable Pin Plug Housing

(71) Applicant: Gregg Wilson, Goleta, CA (US)

(72) Inventor: Gregg Wilson, Goleta, CA (US)

(73) Assignee: STARLIGHTS, INC., Goleta, CA (US)

(21) Appl. No.: 13/542,376

(22) Filed: Jul. 5, 2012

Related U.S. Application Data
(60) Provisional application No. 61/504,320, filed on Jul. 5, 2011.

(51) Int. Cl. F21K 99/00; F21S 8/00

(52) U.S. Cl. CPC F21K 9/30; F21S 8/00
USPC 362/249.03; 362/249.07

(57) ABSTRACT

A light emitting diode (LED) lighting assembly with adjustable pin plug housing is provided for differing types of G4 fixtures with plug angles of 0 degrees, 10 degrees and 90 degrees. The angular adjustment of the light assembly allows lens cover to be reinstalled when in close proximity to other objects and provides a fixture looking normal in everyday use. Due to the limited space inside of the G4 fixture, the LED bulb can use a flexible copper ribbon heat sink attached to the backside of the LED circuit board that can be hidden into a recessed area inside the G4 fixture.

### CROSS REFERENCE TO RELATED APPLICATION

This application claims the benefit of U.S. provisional patent application No. 61/504,320 filed on Jul. 5, 2011, entitled “LIGHT EMITTING DIODE BULB WITH ADJUSTABLE PIN PLUG HOUSING,” the entire contents of which is incorporated by reference.

### BACKGROUND OF THE INVENTION

LED lamps are solid-state devices which are well known in the art that use light-emitting diodes (LEDs) as the source of light. Although LED lamps offer long service life and high energy efficiency their initial costs are often higher than those of fluorescent and incandescent lamps. One drawback of current LED bulb designs is that they include a fixed housing which often can not be adapted to fit all lamp assemblies. This can require a different fixture to be retrofit with the bulb which can be expensive and time consuming.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a first upper perspective view of the pin plug housing according to an embodiment of the present invention.

FIG. 2 illustrates a second upper perspective view of the pin plug housing according to an embodiment of the present invention.

FIG. 3 illustrates a first bottom perspective view of the upper housing assembly showing in FIGS. 2 and 3.

FIG. 4 illustrates a second bottom perspective view as shown in FIG. 3.

FIG. 5 illustrates a side view of the upper housing assembly according to an embodiment of the present invention.

FIG. 6 illustrates an exploded side view showing the upper housing assembly according to an embodiment of the present invention.

FIG. 7 illustrates a first side view of an embodiment of the present invention.

FIG. 8 illustrates a second side view of an embodiment of the present invention.

FIG. 9 illustrates a rear view of an embodiment of the present invention.

FIG. 10 illustrates an exploded view of an embodiment of the present invention.

FIG. 11 illustrates a rear view of an embodiment of the present invention.

FIG. 12 illustrates an exploded view of an embodiment of the present invention.

FIG. 13 illustrates a front view of an embodiment of the present invention.

FIG. 14 illustrates a front view of an embodiment of the present invention.

FIG. 15 illustrates a top view of an embodiment of the present invention.

FIG. 16 illustrates a top exploded view of an embodiment of the present invention.

FIG. 17 illustrates a top view of an embodiment of the present invention.

FIG. 18 illustrates a sectional view showing through section lines A-A in FIG. 17

FIG. 19 illustrates a bottom view of an embodiment of the present invention.

FIG. 20 illustrates a rear view of an embodiment of the present invention.

FIG. 21 illustrates a rear view of an embodiment of the present invention.

FIG. 22 illustrates a side view of an embodiment of the present invention.

FIG. 23 illustrates a top view of an embodiment of the present invention.

FIG. 24 illustrates side view viewed from lines B-B shown in FIG. 23.

FIG. 25 illustrates a side view of an embodiment of the present invention.

FIG. 26 illustrates an exploded view of an embodiment of the present invention.

FIG. 27 illustrates a front view of an embodiment of the present invention.

FIG. 28 illustrates a front view of an alternative embodiment shown in FIG. 27.

FIG. 29 illustrates a front view of another alternative embodiment shown in FIG. 27.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

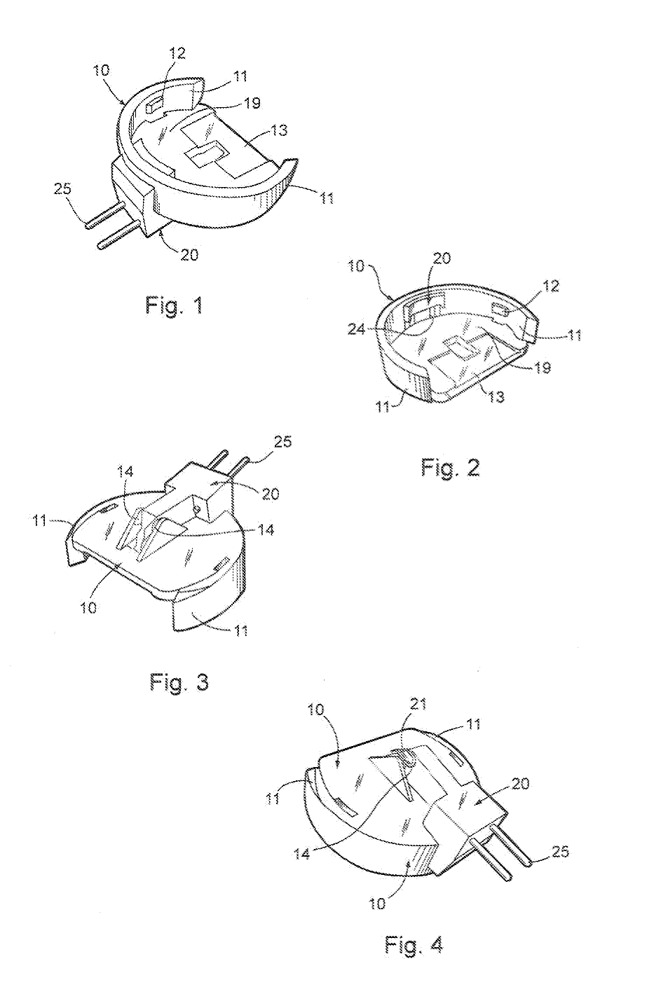

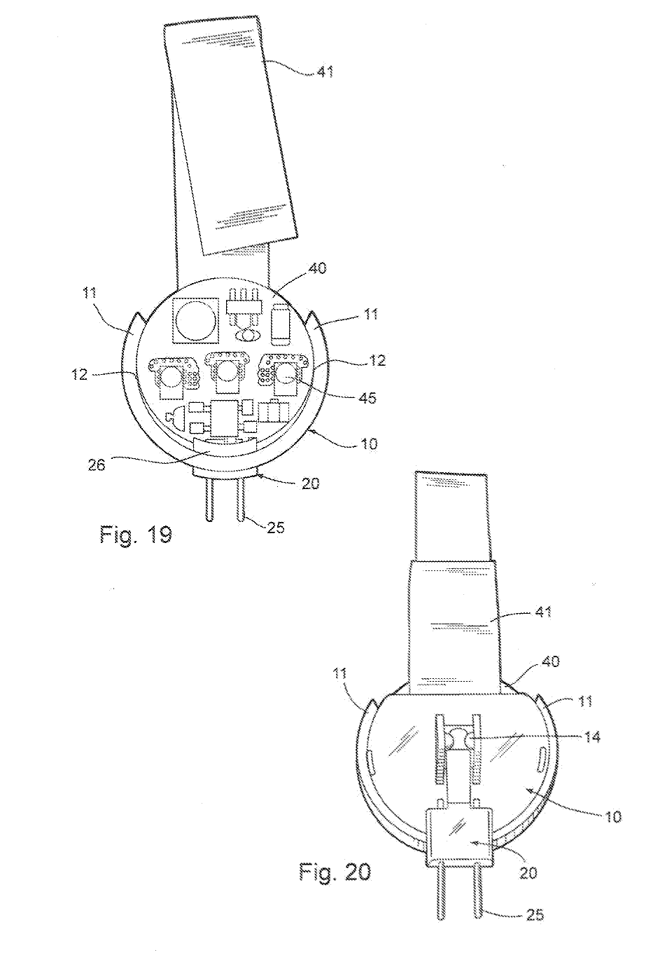

FIG. 1 illustrates a first upper perspective view of the upper housing assembly according to an embodiment of the present invention. FIG. 2 illustrates a second upper perspective view of the pin plug housing according to an embodiment of the present invention. As seen in FIGS. 1 and 2, the upper housing assembly 10 includes compression side walls 11, that hold the LED circuit board 40 securely in the upper housing assembly 10, in a parallel plane to the inside floor 19. Protruding wall tabs 12 are located on the interior side walls of the upper housing assembly 10. As seen in FIG. 19, the wall tabs 12 work to hold the LED circuit board 40 in place so as to be in close proximity to the inside floor 19 of the upper housing assembly 10. The wall tabs 12 prevent the LED circuit board 40 from coming loose in the vertical plane to the upper housing assembly 10 of the inside floor 19. The upper housing assembly 10 includes a floor depression 13 for allowing a copper cooling ribbon 41 to be attached to the bottom of the LED circuit board 40 for allowing the circuit board to fit tightly onto the inside floor 19, of the upper housing assembly 10. Although shown with two plug assemblies 20, 30, the upper housing assembly 10 can be designed to accept a plurality of additional bottom plug assemblies. AS seen in FIG. 6, one of those plug assemblies 20 operates as an adjustable side pin plug assembly that holds plug pins 25. However an alternative embodiment illustrates in FIG. 26, shows a back pin plug assembly 30 that is non-adjustable and positioned at a perpendicular angle to the inside floor 19, of the upper housing assembly 10 with plug pins 25. As seen in FIGS. 2, the power and ground wire grooves 24, that protect the bare wires connecting the LED circuit board 40, with the plug pins 25.

FIG. 3 is a first bottom perspective view of the upper housing assembly showing in FIGS. 1 and 2. As seen in FIG. 3, the upper housing assembly 10, has compression side walls 11, that hold the LED circuit board 40 securely in the upper housing assembly 10, in a parallel plane to the inside floor 19 of the upper housing assembly 10. The upper housing assembly 10 is designed to accept a plurality of bottom plug assemblies where two of those bottom plug assemblies 20, 30. As seen in FIG. 6, one of those plug assemblies 20 is an adjustable side pin plug assembly that in its design holds plug pins 25. The other is a back pin plug assembly 30 and is non-adjustable and at a perpendicular angle to the inside floor 19 of the upper housing assembly 10. Both of the bottom plug assemblies are held into position by the detent balls 14.

FIG. 4 is a second bottom perspective view of the upper housing assembly according to an embodiment of the present invention. As shown in FIG. 4, the upper housing assembly 10, has compression side walls 11, for holding the LED circuit board 40 securely in the upper housing assembly 10, in a parallel plane to the inside floor 19 of the upper housing assembly 10. The upper housing assembly 10, is designed to accept a plurality of bottom plug assemblies, two of those bottom plug assemblies 20, 30. One of those plug assemblies 20, as shown in FIG. 6, is an adjustable side pin plug assembly that holds plug pins while back pin plug assembly 30, shown in FIG. 26, is non-adjustable and at a perpendicular angle to the inside floor 19 of the upper housing assembly 10. As seen in FIG. 26, both of the bottom plug assemblies are held into position by the detent balls 14, that spring into grooves 21 and 22, at the rear of the adjustable side pin plug assembly 20 and a hole 31 on the back pin plug assembly 30. As seen in FIG. 4, the non-used ball lock groove 21, on the rear of the adjustable side pin plug assembly 20 is oriented at the 10° degree plug pin 25, position groove.

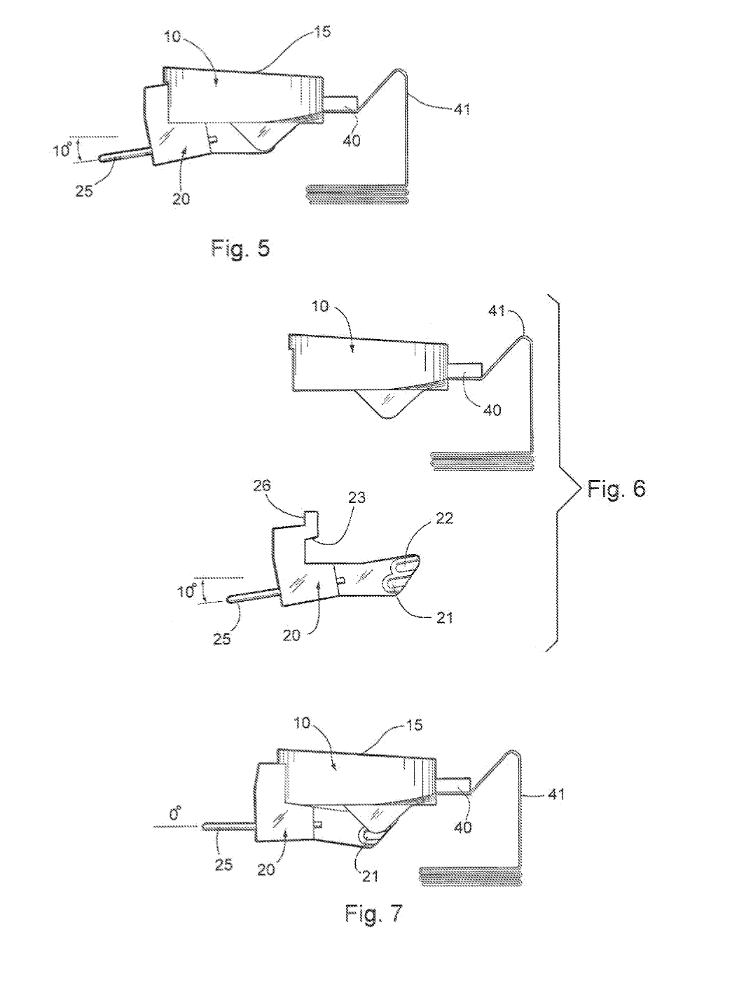

FIG. 5 illustrates a side view of the upper housing assembly according to an embodiment of the present invention. As shown in FIG. 5 the upper housing assembly 10, has a slanted top surface 15, that allows the upper housing assembly 10, to fit or be oriented without interference under a fixtures lens when the fixtures plug assembly is at a 10° degree angle. The adjustable side pin plug assembly 20, with plug pins 25, is installed at a 10° degree angle in to the upper housing assembly 10. FIG. 5 also illustrates the LED circuit board 40, as shown in FIG. 19, with the copper cooling ribbon 41, attached to the bottom of the LED circuit board 40.

FIG. 6 illustrates an exploded side view illustrating the upper housing assembly according to an embodiment of the present invention. As illustrated in FIG. 6, the upper housing assembly 10, shows the LED circuit board 40, with the copper cooling ribbon 41. FIG. 6 shows the adjustable side pin plug assembly 20, with plug pins 25, installed. A lip lock 26, keeps the adjustable side pin plug assembly 20, from slipping out of or coming loose from the upper housing assembly 10. A PCB locking lip 23 is used for holding the LED circuit board 40, with the copper cooling ribbon 41, in conjunction with the protruding wall tabs 12, on the interior side walls of the upper housing 10. The PCB locking lip 23 works to hold the LED circuit board 40 tightly in place to the inside floor 19, of the upper housing assembly 10. Thus, the PCB locking lip 23 prevents the assembly from coming loose in the vertical plane to the upper housing assembly 10, inside floor 19. A 10° ball lock groove 21 and the 0° ball lock groove 22 are positioned on the adjustable side pin plug assembly 20.

FIG. 7 is a side view of an embodiment of the present invention. As shown in FIG. 7, the upper housing assembly 10, has a slanted top surface 15 for allowing the upper housing assembly 10, to fit, without interference, under a fixtures lens when the fixtures plug assembly is at a 10° degree angle. In this embodiment, the adjustable side pin plug assembly 20 with plug pins 25 is installed at a 0° degree angle in to the upper housing assembly 10. The copper cooling ribbon 41 is attached to the bottom of the LED circuit board 40. The 10 degree ball lock grove 21 is shown as unused.

FIG. 8 illustrates an exploded side view according to an embodiment of the present invention. As shown in FIG. 8, the upper housing assembly 10, shows the LED circuit board 40, with an attached copper cooling ribbon 41. The adjustable side pin plug assembly 20, with plug pins 25, is installed and the lip lock 26 keeps the adjustable side pin plug assembly 20, from slipping out of or coming loose from the upper housing assembly 10. The PCB locking lip 23 holds the LED circuit board 40, with the copper cooling ribbon 41, in conjunction with the protruding wall tabs 12, on the interior side walls of the upper housing 10 for holding the LED circuit board 40, in place and tightly adjacent to the inside floor 19 of the upper housing assembly 10, from coming loose in the vertical plane to the upper housing assembly 10, inside floor 19. The 10° ball lock groove 21 and the 0° ball lock groove 22 are located on the adjustable side pin plug assembly 20.

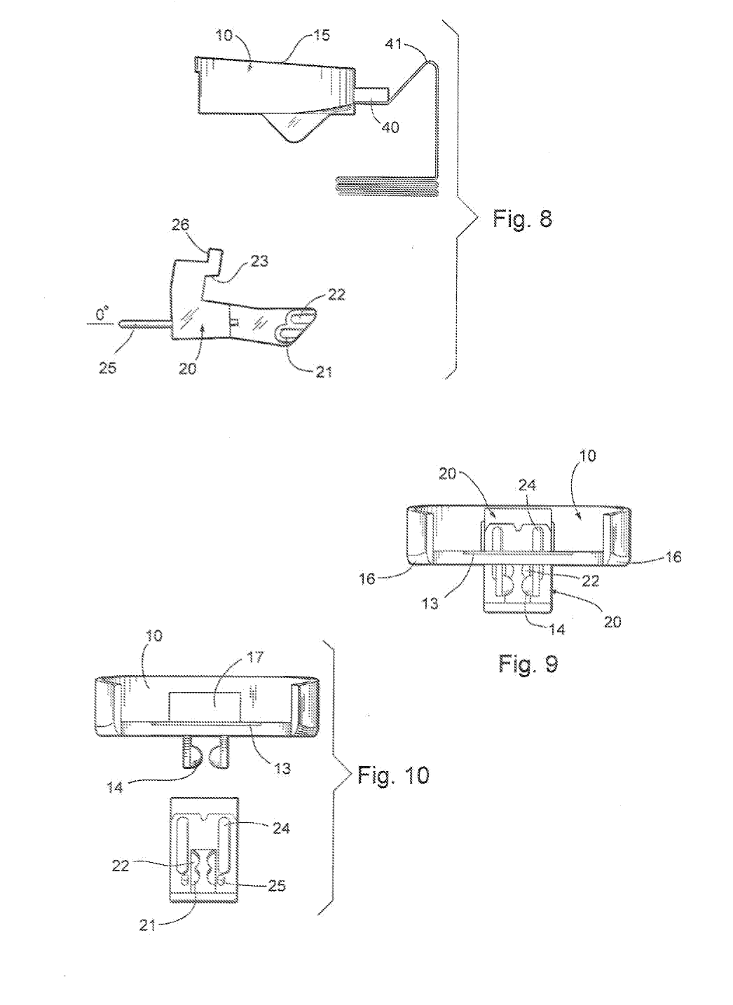

FIG. 9 is a rear view according to an embodiment of the present invention. As shown in FIG. 9, the upper housing assembly 10, has slanted bottom sides 16, at the rear bottom outside of the upper housing assembly 10, to allow the housing to fit the parabolic shape of the reflector mounted in the fixture. The adjustable side pin plug assembly 20 is installed into the upper housing assembly 10, with the detent ball locks 14, in the 10° degree ball lock groove 21 while the 0° degree ball lock groove 22 is unused or empty. The power and ground wire groves 24 are located on the adjustable side pin plug assembly 20 for allowing the LED circuit board 40 to derive power from the plug pins 25 that are located on the adjustable side pin plug assembly 20.

FIG. 10 is an exploded rear view according to an embodiment of the present invention. As shown in FIG. 10, the upper housing assembly 10, has an opening 17, in the front of the upper housing assembly 10 for allowing the adjustable side pin plug assembly 20 or the back pin plug housing 30 to be installed. The adjustable side pin plug assembly 20 is shown with the 10° degree ball lock groove 21, and the 0° degree ball lock groove 22. A floor depression 13 is used in the inside floor 19 for the copper cooling ribbon 41, on the LED circuit board 40. The detent ball lock 14 is shown on the bottom side of the upper housing assembly 10.

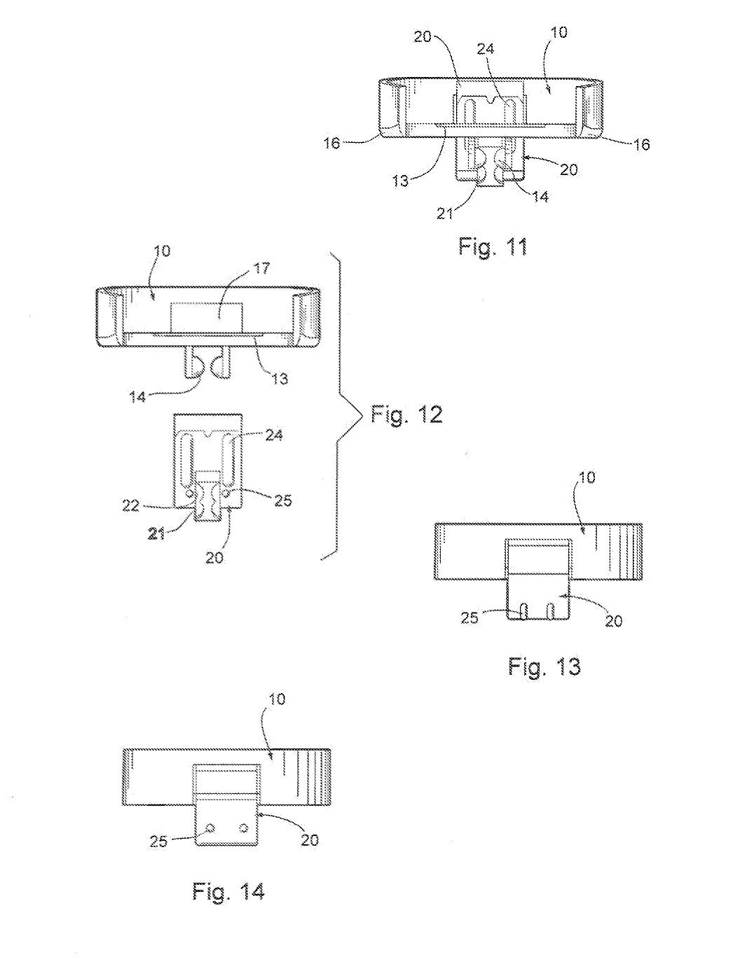

FIG. 11 is a rear view of an embodiment of the present invention. As shown in FIG. 9, the upper housing assembly 10 includes slanted bottom sides 16, at the rear bottom outside of the upper housing assembly 10 for allowing the housing to fit the parabolic shape of the reflector mounted in the fixture. The adjustable side pin plug assembly 20 is installed into the upper housing assembly 10 with the detent ball locks 14, in the 0° degree ball lock groove 22 the 10° degree ball lock groove 21, is unused or empty. The floor depression 13 is shown in the inside floor 19 for the copper cooling ribbon 41 on the LED circuit board 40. The power and ground wire grooves 24 are used to protect the bare wires connecting the LED circuit board 40 with the plug pins 25.

FIG. 12 is an exploded rear view of the present invention. As shown in FIG. 12, the upper housing assembly 10, has an opening 17, in the front of the upper housing assembly 10, for allowing the adjustable side pin plug assembly 20 or the back pin plug housing 30 to be installed. The adjustable side pin plug assembly 20 shows the 10° degree ball lock groove 21 and the 0° degree ball lock groove 22. The floor depression 13, in the inside floor 19 for the copper cooling ribbon 41, on the LED circuit board 40. The detent ball locks 14 are shown on the bottom side of the upper housing assembly 10.

FIG. 13 is a front view of the present invention. As shown in FIG. 13, the upper housing assembly 10, attached to the adjustable side pin plug assembly 20, showing a movable/ratchetable plug pins 25 at a downward 10° degree angle.

FIG. 14 is a front view of the present invention. As shown in FIG. 14, the upper housing assembly 10, attached to the adjustable side pin plug assembly 20, showing plug pins 25, at a 0° degree angle.

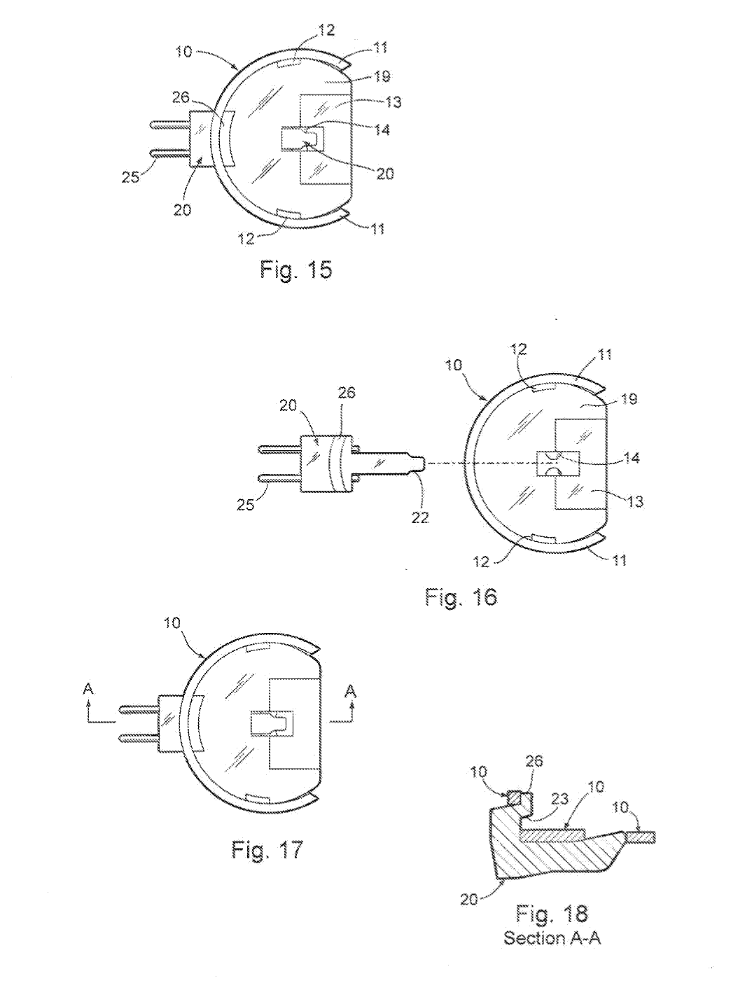

FIG. 15 is a top view of an embodiment of the present invention. As shown in FIG. 15, the upper housing assembly 10, includes compression rear side walls 11 for holding the LED circuit board 40 securely in the upper housing assembly 10, in a parallel plane to the bottom inside floor 19. The protruding wall tabs 12, on the interior side walls of the upper housing 10 work to hold the LED circuit board 40 in place and tight adjacent to the inside floor 19, of the upper housing assembly 10. The wall tabs 12 prevent the LED circuit board 40, from coming loose in the vertical plane to the upper housing assembly 10, inside floor 19. The upper housing assembly 10 includes a floor depression 13, for allowing a copper cooling ribbon 41 to be added to the bottom of the LED circuit board 40. This allows the circuit board 40 to fit tightly onto the inside floor 19, of the upper housing assembly 10. The upper housing assembly 10 is designed to accept one or more bottom plug assemblies. As described herein, two of those bottom plug assemblies are assembly 20 and assembly 30. One of the plug assemblies 20 is an adjustable side pin assembly that holds plug pins 25 and the other is a back pin plug assembly 30 that is non-adjustable and at a substantially perpendicular angle to the inside floor 19, of the upper housing assembly 10. Moreover, its design holds plug pins 25. The adjustable side pin assembly 20 is held into place by the lip lock 26, and the detent ball locks 14.

FIG. 16 is a top exploded view of the present invention. The upper housing assembly 10 included a compression rear side walls 11, that will hold the LED circuit board 40 securely in the upper housing assembly 10, in a parallel plane to the bottom inside floor 19. The protruding wall tabs 12 are located on the interior side walls of the upper housing 10 for holding the LED circuit board 40 in place and tightly adjacent to the inside floor 19, of the upper housing assembly 10, from coming loose in the vertical plane to the upper housing assembly 10, inside floor 19. The upper housing assembly 10 includes a floor depression 13 for allowing copper cooling ribbon 41 to be added to the bottom of the LED circuit board 40. This allows the circuit board to fit tightly onto the inside floor 19, of the upper housing assembly 10. The upper housing assembly 10, is designed to accept many bottom plug assemblies, two of those bottom plug assemblies 20, 30. One of those plug assemblies 20, is an adjustable side pin assembly that in its design holds plug pins 25 while the other is a back pin plug assembly 30, is non-adjustable and at a perpendicular angle to the inside floor 19, of the upper housing assembly 10 and also in its design holds plug pins 25.

FIG. 17 illustrates a top view according to an embodiment of the present invention. As shown FIG. 17, the section view though lines A-A illustrate the adjustable side pin plug assembly 20.

FIG. 18 illustrates a sectional view of an embodiment of the present invention.

As shown in FIG. 18 the section view though lines A-A shows how the adjustable side pin plug assembly 20, locks into the upper housing assembly 10, at the front by using a lip lock 26. The PCB locking lip 23 is used to secure the LED circuit board 40 to the bottom inside floor of the upper housing assembly 10.

FIG. 19 is a top view of an embodiment of the present invention. As shown in

FIG. 19, the upper housing assembly 10, has compression rear side walls 11 that will hold the LED circuit board 40, securely in the upper housing assembly 10. The protruding wall tabs 12 are positioned on the interior side walls of the upper housing 10 for holding the LED circuit board 40, in place and tightly against to the inside floor 19, of the upper housing assembly 10, from coming loose in the vertical plane to the upper housing assembly 10, inside floor 19. The upper housing assembly 10 includes a floor depression 13, for allowing a copper cooling ribbon 41, to be added to the bottom of the LED circuit board 40. This allows the circuit board to fit tightly onto the inside floor 19, of the upper housing assembly 10. The upper housing assembly 10, is designed to accept one or more bottom plug assemblies viz. assemblies 20, 30. One of the plug assemblies 20 is an adjustable side pin plug assembly that in its design holds plug pins 25. The second is a back pin plug assembly 30, that is non-adjustable and at a perpendicular angle to the inside floor 19, of the upper housing assembly 10 and plug pins 25. The adjustable side pin plug assembly 20 is held into place by the lip lock 26. The light emitting diodes 45 are centered on the LED circuit board 40.

FIG. 20 is a bottom view of an embodiment of the present invention. As shown in FIG. 20, the copper cooling ribbon 41, mounted on the back of the LED circuit board 40, and held in place by the compressive rear side walls 11. The adjustable side pin plug assembly 20 is held in place in the upper housing assembly by the detent ball locks 14.

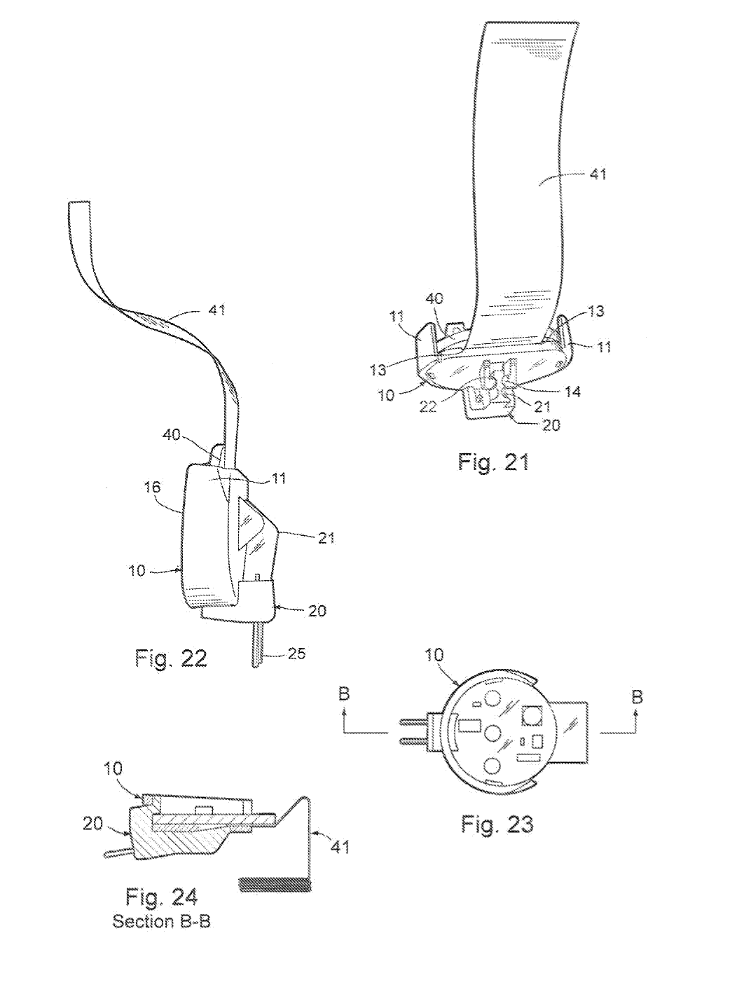

FIG. 21 is a rear view of an embodiment of the present invention. As shown in

FIG. 21 the copper cooling ribbon 41 is mounted on the back of the LED circuit board 40, and is recessed into the floor depression 13. This allows the LED circuit board 40, to rest solidly against the inside floor 19, of the upper housing assembly 10. Those skilled in the art will recognize that the compressive rear side walls 11, hold the LED circuit board 40, from coming lose horizontally to the inside floor 19 by compressing on or “pinching” the LED circuit board 40. In this view, the adjustable pin plug housing 20 is snapped into the 0° degree ball lock groove 22. The 10° degree ball lock groove 21 is un-used.

FIG. 22 is a side view of an embodiment of the present invention. As shown in FIG. 22, the copper cooling ribbon 41 is attached to the LED circuit board 40, which is held in the upper housing assembly 10, by the compression rear side walls 11. FIG. 22 shows the adjustable side pin plug assembly 20 with plug pins 25, installed with the 10° degree ball lock groove un-used. The slanted top surface 16 is positioned on the upper housing assembly 10.

FIG. 23 is a top view of an embodiment of the present invention. As shown in FIG. 23, the dotted outline of a G4 fixture with the upper housing assembly 10, attached to an adjustable side pin plug assembly 20 and is illustrated when properly installed.

FIG. 24 is a section view of an embodiment of the present invention. As shown in FIG. 24, the dotted outline of a G4 fixture with the upper housing assembly 10, attached to an adjustable side pin plug assembly 20, as it would appear when properly installed. It also shows how the copper cooling ribbon 41 is moved to a position which serves as the heat sink for the LED circuit board 40.

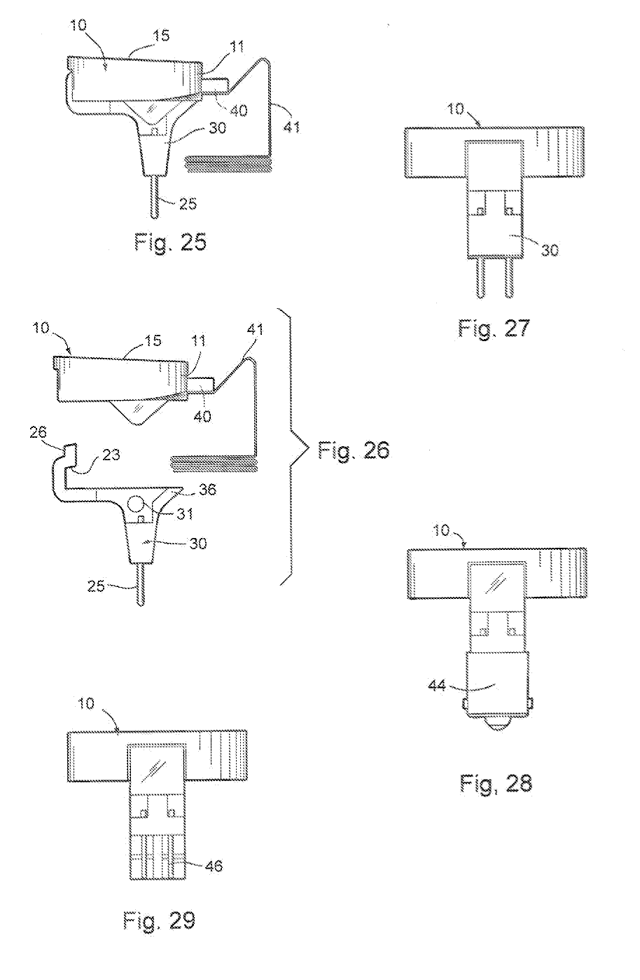

FIG. 25 is a side view of an embodiment of the present invention. As shown in FIG. 25 the upper housing assembly 20 shows the back pin plug assembly 30, with plug pins 25, installed at a vertical angle. The copper cooling ribbon 41 is attached to LED circuit board 40 and is installed into the upper housing assembly 10 that has a slanted top surface 16.

FIG. 26 is an exploded side view of the present invention. As shown in FIG. 26, the upper housing assembly 10 and illustrates the LED circuit board 40, with the copper cooling ribbon 41 and the back pin plug assembly 30, with plug pins 25 installed. The lip lock 26 keeps back pin plug assembly 30, from slipping out of the upper housing assembly 10. FIG. 20 shows the PCB locking lip 23, that also holds the LED circuit board 40, in conjunction with the protruding wall tabs 12, on the interior side walls of the upper housing 10 shown in FIGS. 1, 2, 15 and 16. The locking lip 23 fastens or holds the LED circuit board 40, with copper cooling ribbon 41, in place and tightly against the inside floor 19, of the upper housing assembly 10. This prevents the LED circuit board 40 from becoming loose in the vertical plane to the upper housing assembly 10, inside floor 19. The ball lock hole 31 and the copper ribbon shield 36 keep the conductive ribbon from touching the power wires.

FIG. 27 is a front view of the present invention. As shown in FIG. 27 the upper housing assembly 10, with the Back Pin Plug G4 based assembly 42.

FIG. 28 is a first alternative embodiment of the present invention. As shown in FIG. 28, the upper housing assembly 10 with the alternative embodiment of a Back Plug BA15s based assembly 44.

FIG. 29 is a second alternative embodiment of the present invention. As shown in FIG. 29 the upper housing assembly 10, with the alternative embodiment of a Back Plug W2.1×9.5 d wedge based assembly 46.

Turning again descriptively to the drawings, in which similar reference characters denote similar elements throughout the several views, the figures illustrate the upper housing assembly, and a bottom side adjustable and vertical back plug assembly. The upper housing assembly is used to hold the LED circuit board with a copper cooling ribbon in place securely, provide a locking pivot opening for the bottom plug assembly and provide the ball lock for the bottom plug assembly. The upper housing assembly 10, which could be made of plastic, wood, rubber, glass, steel, aluminum or other material that can hold a form. The upper housing assembly 10, is round in form with an opening 17, in the front to allow the insertion of a bottom plug assemblies such as the adjustable side pin plug assembly 20.

The top of the upper housing assembly 10, has a slanted top surface 15, that slants from the front of upper housing assembly 10, or where the opening 17 is, to the open rear of the upper housing assembly 10, allowing the housing to fit into fixtures where the power plug is not parallel with the surface lens but at an angle. From the back of the upper housing assembly 10, can be seen, the opening for the back pin plug assemblies 30, 42, 44 and 46, to insert into and lock using the lip lock 32, on the top of the Back Pin plug assemblies 30, 42, 44 and 46, housings. Once the LED circuit board 40, with the copper cooling ribbon 41, is installed into the housing inside floor 19, the floor depression 13, allows the copper cooling ribbon 41, on the back of the LED circuit board 40, an area of recess or storage for allowing the LED circuit board 40, to rest flat against the inside floor 19, and held in place vertically by the wall tabs 12, the PCB locking lip 23 and horizontally by the compression rear side walls 11. The upper housing assembly 10, has on the bottom the detent ball locks 14, that fits into the ball lock grooves 21 and 22, and is an adjustable side pin plug assembly 20, and a single ball lock hole 31, designed into the back pin plug assemblies 30, 44 and 46, housings. Those skilled in the art will further recognize that the bottom rear of the upper housing assembly 10 there are slanted bottom sides 16 that give clearance against the parabolic reflectors found in most fixtures.

Those skilled in the art will recognize that the upper housing assembly 10, can be made square, octagon, star or even half domed in shape. It could be designed to incorporate a lens on the front face to cover the LED circuit board 40, and that lens could be of differing colors such as but limited to, red, green, blue and yellow. Is used to provide one of the locking mechanisms, lip lock 26, to hold the bottom side pin plug assembly 20, and the back pin plug alternative embodiments together, the other locking mechanism is the ball lock sockets for tilt angles of 0 degrees and 10 degrees, also with the help of the PCB locking lip 23, this works to hold the LED circuit board 40, in place securely and to it is held the contact plug pins 25 at the correct spacing.

The adjustable side pin plug assembly 20, can be made of plastic, wood, rubber, glass, steel, aluminum or other material that can hold a form. The adjustable side pin plug assembly 20, has a lip lock 26 that holds the adjustable side pin plug assembly 20, securely locked in the upper housing assembly 10. The adjustable side pin plug assembly 20, also has a PCB locking lip 23 that clamps down on the LED circuit board 40, to help hold it in place. Also embodied on the adjustable side pin plug assembly 20, are ball lock grooves 21, 22. Ball lock groove 22 s the plug to 0° degrees and ball lock groove 21 angles the plug to 10° degrees. The adjustable side pin plug assembly 20, also holds the plug pins 25. The adjustable side pin plug assembly 20 and the back pin plug variations, the power and ground wire grooves 24, that allow the power wires to connect to the LED circuit board 40 are also illustrated herein.

The bottom adjustable side pin plug assembly 10, can be extended to reach a recessed plug in a G4 housing and is used to provide one of the locking mechanisms, lip lock 26, to hold the back pin plug assembly 30, together, the other locking mechanism is the ball lock hole 31, also with the help of the PCB locking lip 23, it will help hold the LED circuit board 40, in place securely and it will hold the contact plug pins 25, at the correct spacing. The back pin plug assembly 30, can be made of plastic, wood, rubber, glass, steel, aluminum or other material that can hold a form. The back pin plug assembly 30, has a lip lock 26 that holds the Back pin plug assembly 30, securely locked in the upper housing assembly 10. The bottom back pin plug assembly 30, also has a PCB locking lip 28, that clamps down on the LED circuit board 40, to help hold it in place. Also embodied on the back pin plug assembly 30, is a ball lock hole 31. The back pin plug assembly 30, also holds the contact power plug pins 25. The back pin plug assembly 30, the power and ground wire grooves 24 for allowing the power wires to connect to the LED circuit board 40 are also illustrated herein.

The back pin plug assembly 30, has other variants that give the upper housing assembly 10, more functionality, they could be but not limited to as pictured in FIG. 28, a Back Plug BA15s Based Assembly 44, or as pictured in FIG. 29, a Back Plug W2.1×9.5 d wedge based assembly 46. This is a LED circuit board with the copper ribbon attached. The LED circuit board 40, holds the light emitting diodes 45, and other electronic parts necessary for the operation of the bulb and more importantly it attaches to the copper cooling ribbon 41 that functions as a heat sink to keep those components cool. The LED circuit board 40, can be made in many shapes to accommodate the upper housing assembly shape. It can also be designed to hold up to 3 light emitting diode 45, also the copper cooling ribbon 41 could be made of gold, silver or other heat conductive material.

The upper housing assembly 10, is attached to the bottom pin plugs 20, 30, 44, 46, by means of a lip lock 26, as shown in FIGS. 6, 8, 18, and 19, that locks to the top inside of the upper housing assembly 10, by means of passing through the opening 17 and rotating around until the detent ball locks 14, snap into the ball lock grooves 21 or 22, depending on what plug angle is desired, as shown in FIGS. 9 & 11, or it would snap into the ball lock hole 31, as shown in FIGS. 25 and 26, when using the back pin plug assembly 30. Variations to the back pin plug assembly 30 would be as pictured in FIG. 28, a BA15s back pin plug assembly 44, or as pictured in FIG. 29, a Bottom Back pin plug assembly W2.1×9.5 d wedge based Assembly 46. The LED circuit board 40, as shown in FIGS. 5, 6, 7, 8 and 20 show where the LED circuit board 40, fits into the housing being held in the vertical plane to the bottom inside floor 19, by the inside wall tabs 12, shown in FIGS. 1, 2, 15, 16 and 19.

The PCB locking lip 23 as shown in FIGS. 6, 8 and 20 was designed into both the adjustable side pin plug assembly 20 and back pin plug assembly 30. LED circuit board 40, is held in place parallel to the bottom inside floor 19, by the compression rear side walls 11, as shown in FIGS. 1, 2, 3, 4, 15, 16, 26. A floor depression 13 is located on the inside floor 19, as shown in FIGS. 1, 2, 9, 10, 11, 12, 15, 16 and 21, for allowing the cooling ribbon attached to the LED circuit board 40, to recess so the LED circuit board 40, can rest on the inside floor 19, without binding the electronic circuit board. The slanted top surface 15, of the upper housing assembly 10, slopes from the front of the upper housing assembly 10, the front being the opening 17, as shown in FIGS. 10 and 12, in the front wall, and slopes back to the rear of the upper housing assembly 10. This allows the upper housing assembly 10, with the adjustable side pin plug assembly 20, to fit into those lighting fixtures where the power plug in the fixture is mounted in a 10° degree up slope from the horizontal plane of the lighting fixtures lens. Also to the rear of the upper housing assembly 10, on the bottom outside corners, the slanted bottom sides 16 are shown from the approximately the middle to the rear on both sides as shown in FIGS. 9 and 11, so the fixture will fit inside the parabolic reflector in the fixture.

The adjustable side pin plug assembly 20, locks into the upper housing assembly 10 by means of a lip lock 26, as shown in FIGS. 6, 8, 16, 18, and 19, that is inserted through the opening 17, as shown in FIGS. 10 and 12. Once inserted, the adjustable side pin plug assembly 20, shown in FIGS. 6, 7, 8, 9, 10, 11 and 12 can be rotated around and snapped into the appropriate ball lock groove 21 or 22, as shown in FIGS. 5, 7, 9 and 11, to place the plug pins 25 at the angle required of the fixture. Also on the same side as the lip lock 26, can be found the PCB locking lip 23, as shown in FIGS. 6, 8 and 26, that clamps the LED circuit board 40, in place. Those skilled in the art will also recognize that on the back or rear of the PCB locking lip 23, there are power and ground wire grooves 24, that keep the power wires that are coming from the power plug pins 25, located on the adjustable side pin plug assembly from touching each other causing a short circuit or from touching some other conductive surface and causing a short circuit.

The back pin plug assembly 30, locks into the upper housing assembly 10 by means of a lip lock 26, as shown in FIGS. 6, 8, 16, 18, and 19, that is inserted through the opening 17, as shown in FIGS. 10 and 12. Once inserted, the back pin plug assembly 30, shown in FIGS. 25 and 26, can be rotated around and snapped into the ball lock hole 31. Also on the same side as the lip lock 26, can be found the PCB locking lip 23, as shown in FIGS. 6, 8 and 26 that clamps the LED circuit board 40, in place. In the rear of the PCB locking lip 23, there are power and ground wire grooves 24, that keep the power wires that are coming from the power plug pins 25, located on the adjustable side pin plug assembly from touching each other causing a short circuit or from touching some other conductive surface and causing a short circuit. The back pin plug assembly 30, also has the copper ribbon shield 36, to keep the very conductive copper cooling ribbon 41, from touching the power wire.

The upper housing assembly 10 can be made square, flower shaped, octagon, star or even half domed in shape. It can be designed to incorporate a lens on the front face to cover the LED circuit board 40, and that lens can be of differing colors such as but limited to red, green, blue and/or yellow. The bottom pin plug assemblies can also have alternate plug ends, such as those in FIGS. 22 and 23. It can be painted in a single color or cast in many colors. It could even be made to resemble a flower and made water tight and used in the garden.

One embodiment of the invention is to be used in the small lighting fixtures that currently use the hot, high power consuming G4 halogen bulbs. The problem with the current puck type LEDs on the market today is that these fixtures are very small in size and the plug angle in some are at a 10 degrees. When trying to place the current puck type LED into a fixture that has a 10 degree angle the user will not be able to replace the lens cover or alternatively the user will damage the lens cover in attempts to replace it. Even in fixtures where the plug angle is 0 degrees, only a very small LED puck type can be used such that light emitted from the fixture is no adequate. But to gain a high level of luminescence the current puck LEDs have to be big and as such will not fit in the housing. The invention is a light emitting diode bulb mounted in a housing using a copper ribbon to cool the LED circuit board, that is small in size, and designed around the parabolic curve of most of the reflectors that are used in the current fixtures on the market today. It will adjust in one configuration using the adjustable side pin plug assembly from 0 degrees to 10 degrees, thus making it adaptive to both the zero (0) degree fixtures and the 10 degree fixtures. With the use of the back pin plug assembly, it can be placed in fixtures where the plug is vertical to the front face of the fixture. As the invention is small in size yet powerful in luminescence this allows the fixture to be positioned in located where a small space is desired and requires a high amount of luminescence.

Hence, embodiments of this invention generally relate to an LED bulb which includes the upper housing assembly, a copper cooling ribbon, and a side adjustable and vertical back plug assembly. The present invention relates generally to LED bulbs and more specifically to a light emitting diode bulb with angularly adjustable pin plug that can adjust and/or ratchet for different types of G4 fixtures allowing plug angles of 0 degrees, 10 degrees and 90 degrees relative to the housing. By allowing the housing to adjust/ratchet to different angles, a lens cover to be reinstalled, leaving the fixture to operate normally without obstructed movement. In view of the limited space inside of a G4 fixture, the bulb utilizes a copper ribbon soldered to the backside of an LED circuit board that serves as a heat sink. The ribbon is flexible and can be positioned or tucked into small and/or confined areas inside the G4 fixture.

An object of one of embodiment of the invention is to provide a light emitting diode bulb that uses a copper cooling ribbon with angularly adjustable pin plug housings for different types of G4 fixtures with plug angles of 0 degrees, 10 degrees and 90 degrees, that will allow the lens cover to be reinstalled, leaving the fixture looking normal in every way, that due to the limited space inside of the G4 fixtures, the bulb will use a copper cooling ribbon soldered to the backside of the LED circuit board, that will serve as a heat sink, that is flexible and can be tucked into a small, out of the way area, inside the G4 fixture.

Another object of another embodiment of the invention is to provide a light emitting diode bulb with adjustable pin plug housing that will contain a circuit board with light emitting diodes, driver copper cooling ribbon and other circuitry that will plug into different types of G4 plug fixtures with plug angles of 0 degrees, 10 degrees and 90 degrees. Another object of an embodiment of the invention is to provide a light emitting diode bulb with adjustable pin plug housing having a bottom adjustable side pin plug assembly that can pivot and/or ratchet from a 0 degree position to a 10 degree position and a back pin plug assembly that will allow the power pins to be vertical to the upper housing. Another object of the invention is to provide a light emitting diode bulb with adjustable pin plug housing that can have a bottom back pin plug assembly that will allow the same upper housing to be placed in G4 fixtures where the pin plug is perpendicular to the fixture lens or the front face of fixture. Another object of the invention is to provide a LED bulb with adjustable pin plug housing that can be installed in G4 fixtures allowing the fixtures cover to be replaced so the fixtures appearance looks normal. Another object of the invention is to provide a light emitting diode bulb with an adjustable pin plug housing that can be installed in G4 fixtures, allowing the fixtures cover to be replaced so the fixture can operate normally.

Another object of the invention is to provide a light emitting diode bulb with adjustable pin plug housing that has a depression on the bottom of the top inside floor of the upper housing that will allow a copper cooling strip to be added to the bottom of the circuit board with LEDs, driver and other circuitry, that will serve as a heat sink, that is flexible and can be tucked into a small, out of the way area, inside the G4 fixture. Another object of the inventing is to provide a light emitting diode bulb With adjustable pin plug housing that has, on the top housing, compression side walls that will hold the circuit board with light emitting diodes, a driver and other circuitry, securely in the upper housing assembly in a parallel plane to the bottom floor of the upper housing assembly. Still another object of the invention is to provide an LED bulb with adjustable pin plug housing that has protruding wall tabs on the interior side walls of the upper housing that will hold the circuit board with LEDs, a driver and other circuitry, in place and tight to the floor of the upper housing assembly.

Other objects and advantages of the invention will become obvious and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application. These and other features, advantages, and objects of the present invention will be further understood and appreciated by those skilled in the art by reference to the following specification, claims, and appended drawings.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

We claim:

1. A lighting assembly comprising:
a housing;
at least one circuit board including at least one lighting device for engaging within the housing;
a plug attached to the housing for providing an electrical connection to the circuit board; and
wherein the plug is adjustable for allowing the housing to be positioned at an angle relative to the plug.

2. A light assembly as in claim 1, wherein the lighting device is a light emitting diode (LED).

3. A light assembly as in claim 1, wherein the plug includes at least one elongated pin.

4. A light assembly as in claim 1, wherein the plug is angularly adjustable for allowing the housing to pivot at a predetermined angle.

5. A light assembly as in claim 4, wherein the predetermined angle of the plug relative to the housing can be positioned at 0 degrees, 10 degrees or 90 degrees.

6. A light assembly as in claim 1, further comprising: at least one heat sink extending from the circuit board.

7. A light assembly as in claim 6, wherein the at least one heat sink is a ribbon.

8. A light assembly as in claim 1, wherein the lighting assembly is used in connection with a tubular lamp.

9. An LED lighting assembly comprising:
a housing having a floor and sidewall;
an electrical connector having at least one pin such that the electrical connector is connected to a portion of the housing; and
wherein the electrical connector pivots about the housing for positioning the electrical connector at a predetermined angle relative to the housing.

10. An LED lighting assembly as in claim 9, further comprising a circuit board including at least one light emitting diode (LED) such that the circuit board attaches within the housing.

11. An LED lighting assembly as in claim 1, wherein the circuit board is attached to the floor by the sidewall.

12. An LED lighting assembly as in claim 9, wherein the electrical connector includes a plurality of pins extending therefrom.

13. An LED lighting assembly as in claim 9, wherein the electrical connector can pivot to angles of 0 degrees, 10 degrees and 90 degrees relative to the housing for facilitating mounting of the LED lighting assembly.

14. An LED lighting assembly as in claim 9, further comprising a heat sink extending from the housing.

15. An LED lighting assembly as in claim 14, wherein the heat sink is a ribbon.

16. An LED lighting assembly as in claim 9, wherein the lighting assembly is used with a tubular lamp.

17. An adjustable pin plug housing for a light emitting diode (LED) lighting assembly comprising:
a housing having a floor and sidewall;
at least one circuit board positioned on the floor and within the sidewall of the housing for mounting at least one LED;
an electrical connector having at least one pin such that the electrical connector is connected to a portion of the housing;
a heat sink extending from the housing for sinking heat from the at least one LED; and
wherein the electrical connector ratchets about the housing for positioning the electrical connector at a predetermined angle relative to the housing.

18. An LED lighting assembly as in claim 17, wherein the electrical connector pivots to angles of 0 degrees, 10 degrees and 90 degrees relative to the housing for facilitating positioning the housing.

19. An LED lighting assembly as in claim 17, wherein the heat sink is a ribbon.

20. An LED lighting assembly as in claim 17, wherein the tubular lamp is an LED replacement for a florescent lamp.
